(19) United States
(12) Patent Application Publication
(10) Pub. No.: US 2019/0130319 A1
(43) Pub. Date: May 2, 2019

(54) SYSTEMS AND METHODS FOR MONITORING AN ON-DEMAND SERVICE

(71) Applicant: BEIJING DIDI INFINITY TECHNOLOGY AND DEVELOPMENT CO., LTD., Beijing (CN)

(72) Inventor: Beibei ZHANG, Beijing (CN)

(73) Assignee: BEIJING DIDI INFINITY TECHNOLOGY AND DEVELOPMENT CO., LTD., Beijing (CN)

(21) Appl. No.: 16/234,102

(22) Filed: Dec. 27, 2018

Related U.S. Application Data
(63) Continuation of application No. PCT/CN2017/085357, filed on May 22, 2017.

(30) Foreign Application Priority Data
Jan. 19, 2017 (CN) 201710039389.4

(51) Int. Cl. G06Q 10/02; G06Q 50/30; G06Q 20/14

(52) U.S. Cl. CPC G06Q 10/02; G06Q 20/14; G06Q 50/30

(57) ABSTRACT

The present disclosure relates to systems and methods for monitoring an on-demand service. The systems may perform the methods to receive a service request from a terminal, wherein the service request may include a departure location and a destination; determine a reference parameter based on the departure location and the destination; determine an actual parameter based on an actual itinerary associated with the service request; estimate a first difference between the reference parameter and the actual parameter; determine whether the first difference exceeds a first threshold; and send a notification to the terminal based on the determination that the first difference exceeds the first threshold.

### CROSS-REFERENCE TO RELATED APPLICATIONS

This application claims priority to Chinese Application No. 201710039389.4 filed on Jan. 19, 2017, the contents of which are incorporated herein by reference.

### TECHNICAL FIELD

The present disclosure generally relates to systems and methods for on-demand services, and in particular, systems and methods for monitoring an on-demand transportation service.

### BACKGROUND

Internet based on-demand transportation services, such as online taxi-calling services, have become increasingly popular because of their convenience of using the services. A system providing an on-demand transportation service may recommend at least one route for a service provider to provide the transportation service to a user. However, when the transportation service is provided, the user has little knowledge as to whether the service provider follows the at least one route recommended by the one-demand transportation service system, and/or whether the service fee for the transportation service is reasonable.

### SUMMARY

According to an aspect of the present disclosure, a system is provided. The system may include at least one storage medium and at least one processor configured to communicate with the at least one storage medium. The at least one storage medium may include a set of instructions for monitoring a service request for an on-demand service. When the at least one processor executes the set of instructions, the at least one processor may be directed to perform one or more of the following operations. The at least one processor may receive the service request from a terminal, wherein the service request may include a departure location and a destination. The at least one processor may determine a reference parameter based on the departure location and the destination. The at least one processor may determine an actual parameter based on an actual itinerary associated with service request. The at least one processor may estimate a first difference between the reference parameter and the actual parameter. The at least one processor may determine whether the first difference exceeds a first threshold. The at least one processor may send a notification to the terminal based on the determination that the first difference exceeds the first threshold.

In some embodiments, the reference parameter may include at least one of a reference fee associated with the service request, a reference mileage associated with the service request, or a reference time associated with the service request.

In some embodiments, the actual parameter may include at least one of an actual fee associated with the actual itinerary, an actual mileage associated with the actual itinerary, or an actual time associated with the actual itinerary.

In some embodiments, the at least one processor may determine at least two of a fee difference between the reference fee and the actual fee, a mileage difference between the reference mileage and the actual mileage, and a time difference between the reference time and the actual time.

In some embodiments, the at least one processor may determine a weighted value of at least two of the fee difference, the mileage difference, and the time difference. The at least one processor may determine the first difference between the reference parameter and the actual parameter based on the weighted value.

In some embodiments, the at least one processor may rank at least two of the fee difference, the mileage difference, and the time difference. The at least one processor may determine one of the ranked at least two of the fee difference, the mileage difference, and the time difference as the first difference between the reference parameter and the actual parameter.

In some embodiments, the at least one processor may obtain traffic information associated with the service request. The at least one processor may determine the reference parameter based on the traffic information.

In some embodiments, the at least one processor may obtain an arrival location associated with the actual itinerary. The at least one processor may determine a second difference between the arrival location and the destination. The at least one processor may determine whether the second difference exceeds a second threshold. The at least one processor may send the notification to the terminal based on the determination that the second difference does not exceed the second threshold.

In some embodiments, the at least one processor may receive a response associated with a service fee of the service request from the terminal with respect to the notification. The at least one processor may send a fee compensation to the terminal based on the response.

In some embodiments, the fee compensation may include a discount coupon, a voucher, a re-determined service fee, or an extra fee.

According to another aspect of the present disclosure, a method is provided. The method may include one or more of the following operations. A processor may obtain the service request. The processor may receive the service request from a terminal, wherein the service request may include a departure location and a destination. The processor may determine a reference parameter based on the departure location and the destination. The processor may determine an actual parameter based on an actual itinerary associated with service request. The processor may estimate a first difference between the reference parameter and the actual parameter. The processor may determine whether the first difference exceeds a first threshold. The processor may send a notification to the terminal based on the determination that the first difference exceeds the first threshold.

In some embodiments, the processor may determine at least two of a fee difference between the reference fee and the actual fee, a mileage difference between the reference mileage and the actual mileage, and a time difference between the reference time and the actual time.

In some embodiments, the processor may determine a weighted value of at least two of the fee difference, the mileage difference, and the time difference. The processor may determine the first difference between the reference parameter and the actual parameter based on the weighted value.

In some embodiments, the processor may rank at least two of the fee difference, the mileage difference, and the time difference. The processor may determine one of the ranked at least two of the fee difference, the mileage difference, and the time difference as the first difference between the reference parameter and the actual parameter.

In some embodiments, the processor may obtain traffic information associated with the service request. The processor may determine the reference parameter based on the traffic information.

In some embodiments, the processor may obtain an arrival location associated with the actual itinerary. The processor may determine a second difference between the arrival location and the destination. The processor may determine whether the second difference exceeds a second threshold. The processor may send the notification to the terminal based on the determination that the second difference does not exceed the second threshold.

In some embodiments, the processor may receive a response associated with a service fee of the service request from the terminal with respect to the notification. The processor may send a fee compensation to the terminal based on the response.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram of an exemplary on-demand service system according to some embodiments of the present disclosure;

FIG. 2 is a schematic diagram illustrating an exemplary computing device according to some embodiments of the present disclosure;

FIG. 3 is a block diagram illustrating an exemplary processing engine according to some embodiments of the present disclosure;

FIG. 4 is a flowchart illustrating an exemplary process for monitoring an on-demand service according to some embodiments of the present disclosure;

FIG. 5 is a flowchart illustrating an exemplary process for sending information associated with a service request to a terminal according to some embodiments of the present disclosure;

FIG. 6 is a schematic diagram illustrating an exemplary user interface for displaying information associated with a service request according to some embodiments of the present disclosure; and

FIG. 7 is a schematic diagram illustrating exemplary hardware and/or software components of an exemplary mobile device on which the terminal may be implemented according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the system and method in the present disclosure is described primarily regarding an on-demand service, it should also be understood that this is only one exemplary embodiment. The system or method of the present disclosure may be applied to any other kind of on demand service. For example, the system or method of the present disclosure may be applied to transportation systems of different environments including land, ocean, aerospace, or the like, or any combination thereof. The vehicle of the transportation systems may include a taxi, a private car, a hitch, a bus, a train, a bullet train, a high-speed rail, a subway, a vessel, an aircraft, a spaceship, a hot-air balloon, a driverless vehicle, or the like, or any combination thereof. The transportation system may also include any transportation system for management and/or distribution, for example, a system for sending and/or receiving an express. The application of the system or method of the present disclosure may include a web page, a plug-in of a browser, a client terminal, a custom system, an internal analysis system, an artificial intelligence robot, or the like, or any combination thereof.

The term “passenger,” “requestor,” “service requestor,” and “customer” in the present disclosure are used interchangeably to refer to an individual, an entity or a tool that may request or order a service. Also, the term “driver,” “provider,” “service provider,” and “supplier” in the present disclosure are used interchangeably to refer to an individual, an entity or a tool that may provide a service or facilitate the providing of the service. The term “user” in the present disclosure may refer to an individual, an entity or a tool that may request a service, order a service, provide a service, or facilitate the providing of the service. For example, the user may be a passenger, a driver, an operator, or the like, or any combination thereof. In the present disclosure, “passenger” and “passenger terminal” may be used interchangeably, and “driver” and “driver terminal” may be used interchangeably.

The term “service request” and “order” in the present disclosure are used interchangeably to refer to a request that may be initiated by a passenger, a requestor, a service requestor, a customer, a driver, a provider, a service provider, a supplier, or the like, or any combination thereof. The service request may be accepted by any one of a passenger, a requestor, a service requestor, a customer, a driver, a provider, a service provider, or a supplier. The service request may be chargeable or free.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

An aspect of the present disclosure relates to systems and methods for monitoring an on-demand service (e.g., an on-demand transportation service). The systems and methods may receive a service request for an on-demand transportation service from a terminal. After the on-demand transportation service is provided, the system may determine a reference parameter (e.g., a reference fee) and/or an actual parameter (e.g., an actual fee) associated with the service request. The systems and methods may also estimate a difference between the reference parameter and the actual parameter. The systems and methods may further determine whether the difference exceeds a threshold and send a notification to the terminal based on the determination that the difference exceeds the threshold. The systems and methods according to the present disclosure dynamically monitor the quality of the on-demand service being provided, and proactively provide feedback with service charge compensation to the user if necessary. Accordingly, the present disclosure improves the quality of services via efficiently monitoring the real-time on-demand transportation service.

It should be noted that online on-demand transportation service, such as online taxi-hailing including taxi hailing combination services, is a new form of service rooted only in post-Internet era. It provides technical solutions to users and service providers that could raise only in post-Internet era. In pre-Internet era, when a user hails a taxi on the street, the taxi request and acceptance occur only between the passenger and one taxi driver that sees the passenger. If the passenger hails a taxi through a telephone call, the service request and acceptance may occur only between the passenger and one service provider (e.g., one taxi company or agent). Online taxi, however, allows a user of the service to real-time and automatically distribute a service request to a vast number of individual service providers (e.g., taxi) distance away from the user. It also allows a plurality of service providers to respond to the service request simultaneously and in real-time. Therefore, through the Internet, the online on-demand transportation systems may provide a much more efficient transaction platform for the users and the service providers that may never meet in a traditional pre-Internet transportation service system.

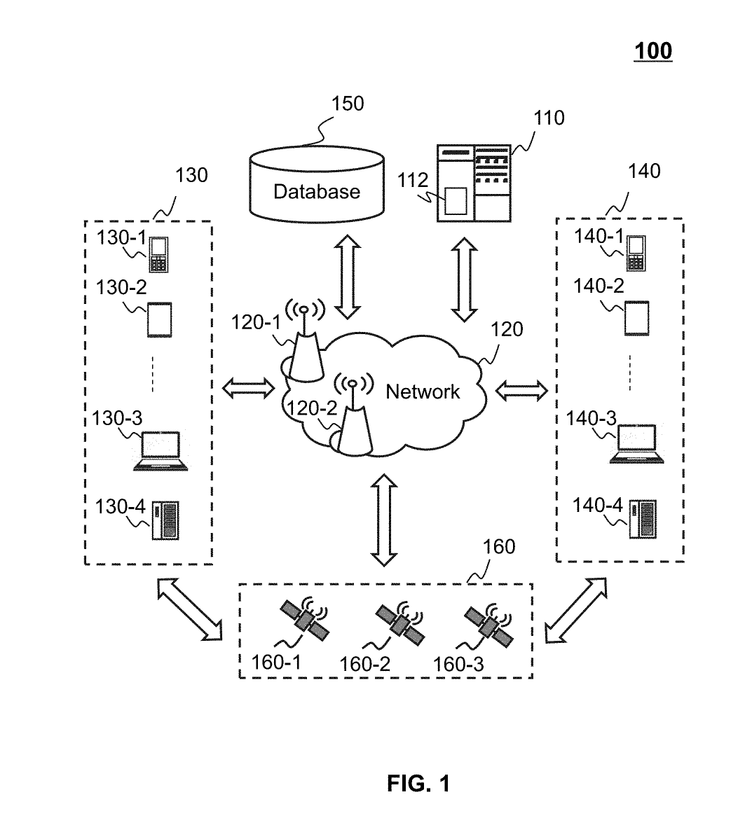

FIG. 1 is a schematic diagram of an exemplary on-demand service system 100 according to some embodiments of the present disclosure. For example, the on-demand service system 100 may be an online transportation service platform for transportation services such as taxi hailing, chauffeur services, delivery vehicles, carpool, bus service, driver hiring and shuttle services. The on-demand service system 100 may be an online platform including a server 110, a network 120, a requestor terminal 130, a provider terminal 140, a database 150, and a positioning system 160. The server 110 may include a processing engine 112.

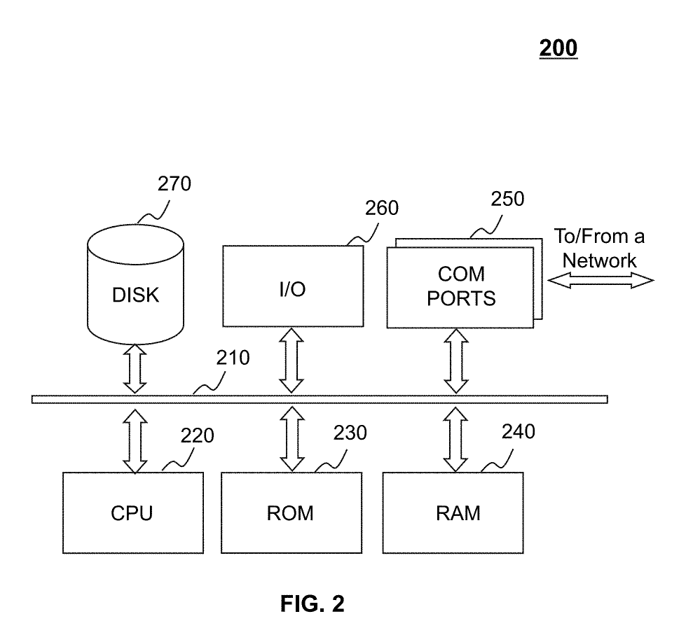

In some embodiments, the server 110 may be a single server or a server group. The server group may be centralized, or distributed (e.g., server 110 may be a distributed system). In some embodiments, the server 110 may be local or remote. For example, the server 110 may access information and/or data stored in the requestor terminal 130, the provider terminal 140, and/or the database 150 via the network 120. As another example, the server 110 may be directly connected to the requestor terminal 130, the provider terminal 140, and/or the database 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data relating to the service request to perform one or more functions described in the present disclosure. For example, the processing engine 112 may determine a reference parameter and an actual parameter associated with the service request obtained from the requestor terminal 130. In some embodiments, the processing engine 112 may include one or more processing engines (e.g., single-core processing engine(s) or multi-core processor(s)). Merely by way of example, the processing engine 112 may include one or more hardware processors, such as a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate the exchange of information and/or data. In some embodiments, one or more components in the on-demand service system 100 (e.g., the server 110, the requestor terminal 130, the provider terminal 140, the database 150, and the positioning system 160) may send information and/or data to other component(s) in the on-demand service system 100 via the network 120. For example, the server 110 may obtain/acquire service request from the requestor terminal 130 via the network 120. In some embodiments, the network 120 may be any type of wired or wireless network, or a combination thereof. Merely by way of example, the network 130 may include a cable network, a wireline network, an optical fiber network, a telecommunications network, an intranet, the Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the on-demand service system 100 may be connected to the network 120 to exchange data and/or information.

In some embodiments, a requestor may be a user of the requestor terminal 130. In some embodiments, the user of the requestor terminal 130 may be someone other than the requestor. For example, a user A of the requestor terminal 130 may use the requestor terminal 130 to send a service request for a user B, or receive service and/or information or instructions from the server 110. In some embodiments, a provider may be a user of the provider terminal 140. In some embodiments, the user of the provider terminal 140 may be someone other than the provider. For example, a user C of the provider terminal 140 may user the provider terminal 140 to receive a service request for a user D, and/or information or instructions from the server 110. In some embodiments, “requestor” and “requestor terminal” may be used interchangeably, and “provider” and “provider terminal” may be used interchangeably.

In some embodiments, the requestor terminal 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a bracelet, footgear, glasses, a helmet, a watch, clothing, a backpack, a smart accessory, or the like, or any combination thereof. In some embodiments, the mobile device may include a mobile phone, a personal digital assistance (PDA), a gaming device, a navigation device, a point of sale (POS) device, a laptop, a desktop, or the like, or any combination thereof. In some embodiments, the virtual reality device and/or the augmented reality device may include a virtual reality helmet, a virtual reality glass, a virtual reality patch, an augmented reality helmet, augmented reality glasses, an augmented reality patch, or the like, or any combination thereof. For example, the virtual reality device and/or the augmented reality device may include a Google Glass™, a RiftCon™, a Fragments™, a Gear VR™, etc. In some embodiments, a built-in device in the motor vehicle 130-4 may include an onboard computer, an onboard television, etc. In some embodiments, the requestor terminal 130 may be a device with positioning technology for locating the position of the requestor and/or the requestor terminal 130.

In some embodiments, the provider terminal 140 may be a device that is similar to, or the same as the requestor terminal 130. In some embodiments, the provider terminal 140 may be a device utilizing positioning technology for locating the position of a user of the provider terminal 140 (e.g., a service provider) and/or the provider terminal 140. In some embodiments, the requestor terminal 130 and/or the provider terminal 140 may communicate with one or more other positioning devices to determine the position of the requestor, the requestor terminal 130, the provider, and/or the provider terminal 140. In some embodiments, the requestor terminal 130 and/or the provider terminal 140 may send positioning information to the server 110.

The database 150 may store data and/or instructions. In some embodiments, the database 150 may store data obtained from the requestor terminal 130 and/or the provider terminal 140. In some embodiments, the database 150 may store data and/or instructions that the server 110 may execute or use to perform exemplary methods described in the present disclosure. In some embodiments, database 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyrisor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the database 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the database 150 may be connected to the network 120 to communicate with one or more components in the on-demand service system 100 (e.g., the server 110, the requestor terminal 130, the provider terminal 140, etc.). One or more components in the on-demand service system 100 may access the data or instructions stored in the database 150 via the network 120. In some embodiments, the database 150 may be directly connected to or communicate with one or more components in the on-demand service system 100 (e.g., the server 110, the requestor terminal 130, the provider terminal 140, etc.). In some embodiments, the database 150 may be part of the server 110.

The positioning system 160 may determine information associated with an object, for example, one or more of the requestor terminal 130, the provider terminal 140, etc. The information may include a location, an elevation, a velocity, or an acceleration of the object, or a current time. For example, the positioning system 160 may determine a current location of the requestor terminal 130. In some embodiments, the positioning system 160 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The location may be in the form of coordinates, such as, latitude coordinate and longitude coordinate, etc. The positioning system 160 may include one or more satellites, for example, a satellite 160-1, a satellite 160-2, and a satellite 160-3. The satellites 160-1 through 160-3 may determine the information mentioned above independently or jointly. The satellite positioning system 160 may send the information mentioned above to the network 120, the requestor terminal 130, or the provider terminal 140 via wireless connections.

In some embodiments, one or more components in the on-demand service system 100 (e.g., the server 110, the requestor terminal 130, the provider terminal 140, etc.) may have permission to access the database 150. In some embodiments, one or more components in the on-demand service system 100 may read and/or modify information relating to the requestor, provider, and/or the public when one or more conditions are met. For example, the server 110 may read and/or modify one or more users' information after a service is completed. As another example, the provider terminal 140 may access information relating to the requestor when receiving a service request from the requestor terminal 130, but the provider terminal 140 may not modify the relevant information of the requestor.

In some embodiments, information exchanging of one or more components in the on-demand service system 100 may be achieved by way of requesting a service. The object of the service request may be any product. In some embodiments, the product may be a tangible product or an immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

FIG. 2 is a schematic diagram illustrating exemplary hardware and software components of a computing device 200 on which the server 110, the requestor terminal 130, and/or the provider terminal 140 may be implemented according to some embodiments of the present disclosure. For example, the processing engine 112 may be implemented on the computing device 200 and configured to perform functions of the processing engine 112 disclosed in this disclosure.

The computing device 200 may be a general-purpose computer or a special-purpose computer; both may be used to implement an on-demand system for the present disclosure. The computing device 200 may be used to implement any component of the on-demand service as described herein. For example, the processing engine 112 may be implemented on the computing device 200, via its hardware, software program, firmware, or a combination thereof. Although only one such computer is shown, for convenience, the computer functions relating to the on-demand service as described herein may be implemented in a distributed fashion on a number of similar platforms, to distribute the processing load.

The computing device 200, for example, may include COM ports 250 connected to and from a network connected thereto to facilitate data communications. The computing device 200 may also include a central processing unit (CPU) 220, in the form of one or more processors, for executing program instructions. The exemplary computer platform may include an internal communication bus 210, program storage and data storage of different forms, for example, a disk 270, and a read only memory (ROM) 230, or a random access memory (RAM) 240, for various data files to be processed and/or transmitted by the computer. The exemplary computer platform may also include program instructions stored in the ROM 230, RAM 240, and/or any other type of non-transitory storage medium to be executed by the CPU 220. The methods and/or processes of the present disclosure may be implemented as the program instructions. The computing device 200 also includes an I/O component 260, supporting input/output between the computer and other components therein. The computing device 200 may also receive programming and data via network communications.

Merely for illustration, only one CPU and/or processor is illustrated in the computing device 200. However, it should be noted that the computing device 200 in the present disclosure may also include multiple CPUs and/or processors, thus operations and/or method steps that are performed by one CPU and/or processor as described in the present disclosure may also be jointly or separately performed by the multiple CPUs and/or processors. For example, if in the present disclosure the CPU and/or processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

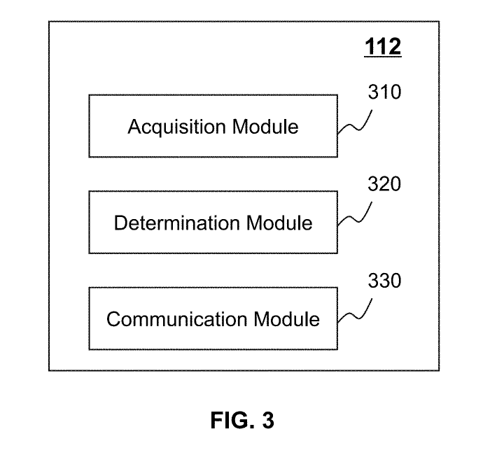

FIG. 3 is a block diagram illustrating an exemplary processing engine 112 according to some embodiments of the present disclosure. The processing engine 112 may include an acquisition module 310, a determination module 320, and a communication module 330.

The acquisition module 310 may be configured to obtain one or more service requests. The acquisition module 310 may obtain a service request from a terminal (e.g., the requestor terminal 130) via the network 120. The acquisition module 310 may analyze the service request and determine information related to the service request (e.g., a departure location, a start time, a destination, etc.).

In some embodiments, the service request may be a request for a transportation service. The service request may include information associated with a requestor that requests for the transportation service. The information associated with the requestor may include profile information of the requestor, request preference of the requestor, or the like, or a combination thereof. The profile information of the requestor may include, for example, the name of the requestor, the age of the requestor, the gender of the requestor, the date of birth of the requestor, a city in which the requestor resides, or the like, or a combination thereof. The request preference may refer to the requestor's requirements about the transportation service. For example, the requestor terminal 130 may determine a preference parameter (e.g., a vehicle type, a size of the trunk, a load of a vehicle, etc.) from the service request based on an input of the requestor. As another example, the request preference may include an indication about whether the requestor agrees to share the transportation service with other requestors in the service request.

The acquisition module 310 may further obtain relevant information associated with the service request. For example, the acquisition module 310 may obtain traffic information (e.g., traffic congestion information, traffic control information, traffic barrier information, etc.) associated with the service request. As another example, the acquisition module 310 may obtain weather information associated with the service request.

The determination module 320 may be configured to determine a reference parameter associated with the service request, an actual parameter associated with the service request, and/or any information associated with the service request. For example, the determination module 320 may determine the reference parameter based on the departure location and the destination. As another example, the determination module 320 may determine the actual parameter based on an actual itinerary associated with the service request.

In some embodiments, the determination module 320 may further determine a first difference between the reference parameter and the actual parameter. The determination module 320 may determine whether an abnormality (e.g., an unnecessary detour by a service provider) occurred during the transportation service based on the first difference. The determination module 320 may further generate a notification associated with the abnormality. In some embodiments, the determination module 320 may further determine a second difference between an arrival location and the destination. As used herein, the arrival location may refer to an actual location where the service provider dropped off the requestor. In some embodiments, the determination module 320 may further generate a bill of the service request indicative of a service fee for the transportation service provided with respect to the service request.

The communication module 330 may be configured to send information associated with the service request to a requestor terminal (e.g., the requestor terminal 130). For example, the communication module 330 may send the reference parameter and/or the actual parameter to the requestor terminal 130. As another example, the communication module 330 may send the notification associated with the abnormality to the requestor terminal 130. As a further example, the communication module 330 may send the bill of the service request to the requestor terminal 130 when the transportation service is finished.

In some embodiments, the communication module 330 may receive a response from the requestor terminal 130. The response may indicate whether the requestor has any questions about the transportation service, whether the requestor needs any help associated with service request, etc.

In some embodiments, upon receiving the response from the requestor terminal 130, the communication module 330 may transmit the response to the determination module 320, and further send a reply (e.g., a fee compensation) generated by the determination module 320 to the requestor terminal 130. For example, in response to receiving a request for re-determining the service fee, the communication module 330 may transmit the request for re-determining the service fee to the determination module 320, and further send a re-determined service fee to the requestor terminal 130. As another example, in response to a request for disputing a service fee, the communication module 330 may transmit the request for disputing a service fee to the determination module 320, and further send a service fee adjustment notification to the requestor terminal 130.

In some embodiments, the information associated with the service request (e.g., the notification, the response, the reply, etc.) may be transmitted and/or received via a message using any suitable communication protocol (e.g., the Hypertext Transfer Protocol (HTTP), Address Resolution Protocol (ARP), Dynamic Host Configuration Protocol (DHCP), File Transfer Protocol (FTP), etc.).

The modules in the processing engine 112 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined as a single module, and any one of the modules may be divided into two or more units. For example, the acquisition module 310 may be integrated into the determination module 320 as a single module which may both obtain the service request and determine the reference parameter and/or the actual parameter associated with the service request. As another example, the processing engine 112 may include a storage module (not shown in FIG. 3) which may be configured to store the service request and/or the information associated with the service request.

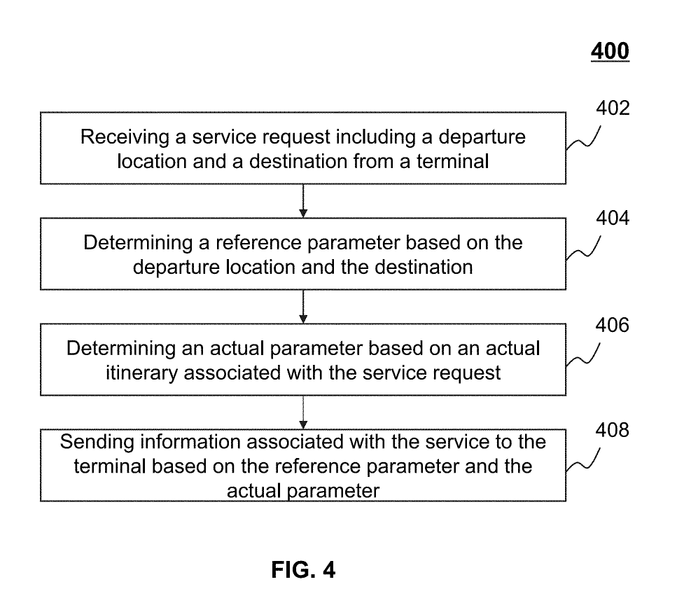

FIG. 4 is a flowchart illustrating an exemplary process/method 400 for monitoring an itinerary according to some embodiments of the present disclosure. The process and/or method 400 may be executed by the on-demand service system 100. For example, the process and/or method 400 may be implemented as a set of instructions (e.g., an application) stored in the storage ROM 230 or RAM 240. The CPU 220 may execute the set of instructions and may accordingly be directed to perform the process and/or method 400. The operations of the illustrated process/method presented below are intended to be illustrative. In some embodiments, the process/method may be accomplished with one or more additional operations not described, and/or without one or more of the operations discussed. Additionally, the order in which the operations of the process/method as illustrated in FIG. 4 and described below is not intended to be limiting.

In step 402, the processing engine 112 may obtain a service request from a terminal (e.g., the requestor terminal 130). The service request may include a departure location and a destination. As used herein, the departure location may refer to a location where a service provider may pick up the requestor. The destination may refer to a location where the service provider may drop off the requestor.

In some embodiments, the service request may be a request for a transportation service (e.g., a taxi service). The service request may include a real-time request, an appointment request, and/or any other request for one or more types of services. As used herein, the real-time request may indicate that the requestor wishes to use the transportation service at the present moment or at a defined time range with respect to the present moment. For example, a service request may be a real-time request if the defined time range is within a threshold value with respect to the present moment, i.e., 8:30 am, such as within 1 minute ahead of 8:30 am, within 5 minutes ahead of 8:30 am, 10 minutes, within 20 minutes ahead of 8:30 am, etc. The service request with an indicated start time beyond the defined time range may be classified as the appointment request. For example, a service request may be classified as an appointment request if the indicated start time is beyond the defined time range, i.e., beyond 20 minutes ahead of the present time, beyond 2 hours ahead of the present time, beyond 1 day ahead of the present time, etc. In some embodiments, the processing engine 112 may define the real-time request or the appointment request based on a time threshold. The time threshold may be a default setting of the on-demand service system 100, or may be adjustable depending on different situations. For example, in a traffic peak period, the time threshold may be relatively small (e.g., 10 minutes), while in an idle period (e.g., 10:00-12:00 am), the time threshold may be relatively large (e.g., 1 hour).

In step 404, the processing engine 112 may determine a reference parameter based on the departure location and the destination.

In some embodiments, the processing engine 112 may determine a recommended route based on the departure location and the destination. Further, the processing engine 112 may determine the reference parameter based on the recommended route. The processing engine 112 may determine a plurality of candidate routes based on the departure location and the destination. In some embodiments, the processing engine 112 may determine the recommended route from the plurality of candidate routes based on a plurality of distances corresponding to the plurality of candidate routes. For example, the processing engine 112 may identify the shortest distance from the plurality of distances and select a candidate route associated with the shortest distance as the recommended route. In some embodiments, the processing engine 112 may determine the recommended route from the plurality of candidate routes based on a plurality of traffic conditions corresponding to the plurality of candidate routes. For example, the processing engine 112 may evaluate the traffic conditions associated with the plurality of candidate routes and select a candidate route with the best traffic condition as the recommended route.

In some embodiments, the reference parameter may include a reference fee, a reference mileage, a reference time, or the like, or a combination thereof. As used herein, the reference fee may refer to an estimated service fee for the transportation service. The reference mileage may refer to an estimated mileage from the departure location to the destination. The reference time may refer to an estimated time period for a service provider to drive from the departure location to the destination.

For example, the processing engine 112 may determine the reference fee according to formula (1) shown below:

Fᵣ=Fₛ+(M_{c}−Mₛ)×Pᵤ+(Mᵣ−M_{c})×Pᵣ, (1)

where Fᵣ may refer to the reference fee; Fₛ may refer to a staring fare; Mₛ may refer to a starting mileage; M_{c} may refer to a critical mileage point between a short trip and a long trip; Pᵤ may refer to a first unit price per kilometer for a short trip; Mᵣ may refer to the reference mileage; and Pᵣ may refer to a second unit price per kilometer for a long trip.

As another example, the processing engine 112 may determine the reference time based on the reference mileage and a reference speed of a vehicle according to formula (2) shown below:

$${T}_{r} = \frac{{M}_{r}}{{S}_{r}} , \qquad ( 2 )$$

where Tᵣ may refer to the reference time; and Sᵣ may refer to the reference speed. As used herein, the processing engine 112 determine the reference speed based on historical information of the vehicle. For example, the processing engine 112 may determine the reference speed by averaging historical speeds of the vehicle within a specific time period (e.g., in the past 1 month).

In some embodiments, when determining the reference parameter, the processing engine 112 may also take environmental information (e.g., traffic information, weather information, etc.) into consideration. As used herein, the traffic information may include traffic congestion information, traffic control information, traffic barrier information, etc.

The processing engine 112 may obtain the traffic information from the database 150, a map service (e.g., a Google Map™, a Tencent Map™, a Baidu Map™), and/or any other service that can provide traffic information in a geographic area. For example, in response to receiving a real-time request, the processing engine 112 may obtain a departure location A and a destination B based on the real-time request. The processing engine 112 may access the database 150 to obtain real-time traffic status related to the departure location A, the destination B, and/or a recommended route from A to B. The processing engine 112 may further determine a reference time for a service provider to drive from A to B based on the real-time traffic status. As another example, in response to receiving an appointment request, the processing engine 112 may obtain a departure location C, a destination D, and a start time 8:00 p.m. on next Monday based on the appointment request. The processing engine 112 may access the database 150 to obtain historical traffic status of 8:00 p.m. from C to D in the past four Mondays and further determine a reference time for a service provider to drive a vehicle from C to D based on the historical traffic status.

In step 406, the processing engine 112 may determine an actual parameter based on an actual itinerary associated with the service request. The actual parameter may include an actual fee associated with the actual itinerary, an actual mileage associated with the actual itinerary, an actual time associated with the actual itinerary, etc.

In an application scenario for a transportation service, the service request may be accepted by a service provider (e.g., a driver). After the service provider picks up the requestor at the departure location, the processing engine 112 may monitor a service fee, a service mileage, a service time in real time during the transportation service. After the service provider drops off the requestor at the destination, the processing engine 112 may terminate the monitoring and determine the actual fee, the actual mileage, and the actual time.

In step 408, the processing engine 112 may send information associated with the service request to the requestor terminal (e.g., the requestor terminal 130) based on the reference parameter and the actual parameter. For example, the processing engine 112 may send the reference parameter and/or the actual parameter to the requestor terminal 130. As another example, the processing engine 112 may send a notification associated with the reference parameter and the actual parameter to the requestor terminal 130. As a further example, the processing engine 112 may send the bill of the service request to the requestor terminal 130 when the transportation service is completed.

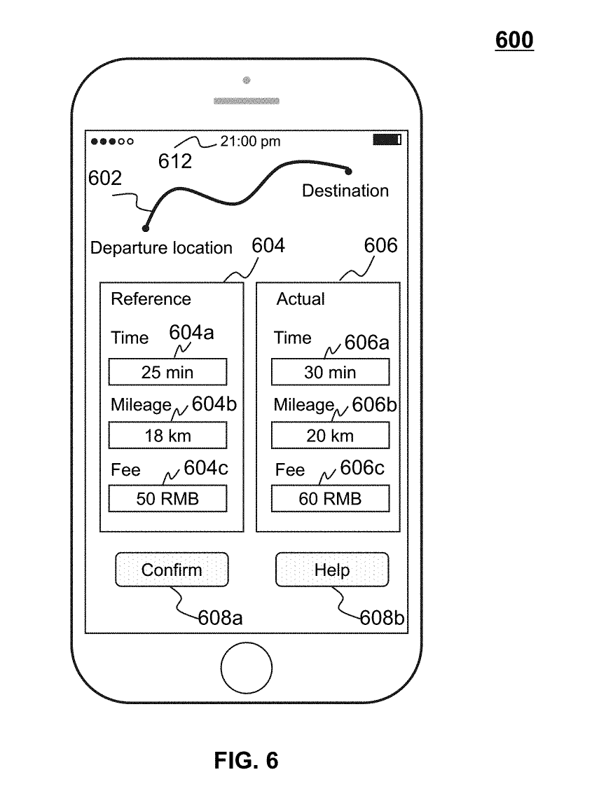

In some embodiments, the received information associated with the service request may be presented with the service request on the requestor terminal 130 in a format of text, images, video content, audio content, graphics, and the combination thereof. For example, the information associated with the service request may be presented on one or more user interfaces of the requestor terminal 130, such as a user interface 600 described in connection with FIG. 6.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step) may be added elsewhere in the exemplary process/method 400.

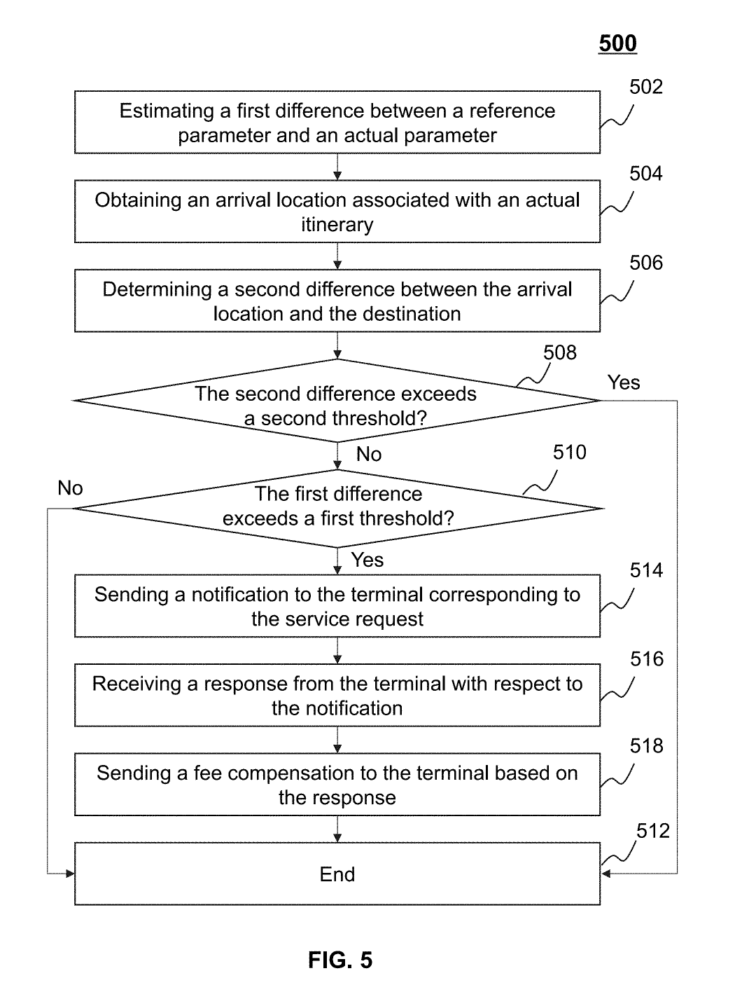

FIG. 5 is a flowchart illustrating an exemplary process/method 500 for sending information associated with a service request to a terminal according to some embodiments of the present disclosure. The process and/or method 500 may be executed by the on-demand service system 100. For example, the process and/or method 500 may be implemented as a set of instructions (e.g., an application) stored in the storage ROM 230 or RAM 240. The CPU 220 may execute the set of instructions and may accordingly be directed to perform the process and/or method 500. The operations of the illustrated process/method presented below are intended to be illustrative. In some embodiments, the process/method may be accomplished with one or more additional operations not described, and/or without one or more of the operations discussed. Additionally, the order in which the operations of the process/method as illustrated in FIG. 5 and described below is not intended to be limiting.

In step 502, the processing engine 112 may estimate a first difference between a reference parameter and an actual parameter. The first difference between the reference parameter and the actual parameter may include a fee difference between the reference fee and the actual fee, a mileage difference between the reference mileage and the actual mileage, a time difference between the reference time and the actual time, etc.

For example, the processing engine 112 may determine the fee difference according to formula (3) shown below:

$${F}_{d} = \frac{{F}_{a} - {F}_{r}}{{F}_{r}} \qquad ( 3 )$$

where F_{d} may refer to the fee difference between the reference fee and the actual fee; Fₐ may refer to the actual fee; and Fᵣ may refer to the reference fee.

As another example, the processing engine 112 may determine the mileage difference according to formula (4) shown below:

$${M}_{d} = \frac{{M}_{a} - {M}_{r}}{{M}_{r}} \qquad ( 4 )$$

where M_{d} may refer to the mileage difference between the reference mileage and the actual mileage; Mₐ may refer to the actual mileage; and Mᵣ may refer to the reference mileage.

As a further example, the processing engine 112 may determine the time difference according to formula (5) shown below:

$${T}_{d} = \frac{{T}_{a} - {T}_{r}}{{T}_{r}} , \qquad ( 5 )$$

where T_{d} may refer to the time difference between the reference time and the actual time; Tₐ may refer to the actual time; and Tᵣ may refer to the reference time.

In some embodiments, the processing engine 112 may assign a weighting coefficient to each of the fee difference, the mileage difference, and the time difference. Further, the processing engine 112 may select at least two of the fee difference, the mileage difference, and the time difference, and determine the first difference based on their respective weighting coefficients.

For example, the processing engine 112 may determine a weighted value of the fee difference, the mileage difference, and the time difference according to formula (6) shown below:

D=F_{d}×W_{f}+M_{d}×Wₘ+T_{d}×Wₜ, (6)

where D may refer to the weighted value; F_{d} may refer to the fee difference; W_{f} may refer to a first weighting coefficient associated with the fee difference; M_{d} may refer to the mileage difference; Wₘ may refer to a second weighting coefficient associated with the mileage difference; T_{d} may refer to the time difference; and Wₜ may refer to a third weighting coefficient associated with the time difference.

The values of the weighting coefficients including W_{f}, Wₘ, and Wₜ may be default settings of the on-demand service system 100, or may be adjustable depending on different situations. For example, by default, W_{f} may be 0.5, Wₘ may be 0.3, and Wₜ may be 0.2. As another example, in a traffic peak period, the third weighting coefficient Wₜ for the time difference may be adjusted to be smaller than the default value 0.2.

In some embodiments, the processing engine 112 may rank at least two of the fee difference, the mileage difference, and the time difference. Further, the processing engine 112 may determine one of the ranked at least two of the fee difference, the mileage difference, and the time difference as the first difference between the reference parameter and the actual parameter. For example, the processing engine 112 may determine the maximum one, the minimum one, the second maximum one, etc. of the fee difference, the mileage difference, and the time difference as the first difference between the reference parameter and the actual parameter.

In step 504, the processing engine 112 may obtain an arrival location associated with an actual itinerary. The arrival location associated with the actual itinerary may refer to an actual location where the service provider drops off the requestor.

In step 506, the processing engine 112 may determine a second difference between the arrival location and the destination. For example, the processing engine 112 may determine a distance between the arrival location and the destination. As used herein, the “distance” may refer to a straight-line distance or a spatial distance (e.g., a length of a portion of a road or a street).

In step 508, the processing engine 112 may determine whether the second difference exceeds a second threshold. The second threshold may be default settings of the on-demand service system 100 (e.g., 0.2 km, 0.3 km, 0.5 km, 1 km, etc.), or may be adjustable based on an instruction from a user.

In response to the determination that the second difference exceeds the second threshold, the processing engine 112 may execute the process/method 500 to step 512 to end the process/method 500. In this situation, the processing engine 112 may generate a bill indicative of a service fee for the completed transportation service based on the actual parameter (e.g., the actual fee) and transmit the bill to the terminal (e.g., the requestor terminal 130).

In response to the determination that the second difference is less than or equal to the second threshold, the processing engine 112 may execute the process/method 500 to step 510. In step 510, the processing engine 112 may determine whether the first difference exceeds a first threshold. The first threshold may be default settings of the on-demand service system 100 (e.g., 0.3, 0.4, 0.5, etc.), or may be adjustable based on an instruction from a user.

In response to the determination that the first difference is less than or equal to the first threshold, the processing engine 112 may execute the process/method 500 to step 512 to end the process/method 500.

In response to the determination that the first difference exceeds the first threshold, the processing engine 112 may execute the process/method 500 to step 514. In step 514, the processing engine 112 may send a notification to the terminal corresponding to the service request. As used herein, the notification may be used to notify the requestor that an abnormality (e.g., an unnecessary detour by the service provider) may occur during the transportation service.

In some embodiments, the notification may include the reference parameter associated with the service, the actual parameter associated with the actual itinerary, the first difference between the reference parameter and the actual parameter, the actual itinerary, a prompt message associated with the actual itinerary, or the like, or a combination thereof.

In some embodiments, the notification may be presented in a format of text, image, video, content, audio content, graphics, or the combination thereof. For example, the terminal may present the notification via a voice broadcast to notify the requestor that the service provider may have detoured during the transportation service.

In some embodiments, while sending the notification to the terminal, the processing engine 112 may determine whether an automatic payment has been set by the requestor. As used herein, the automatic payment may refer to a payment without a password according to a payment agreement with a payment application (e.g., Alipay™, WeChat pay™, Baidu Wallet™, PayPal™ etc.) that has been bound with the on-demand service system 100. As used herein, the payment agreement may include “pay automatically when the service fee is less than 2 dollars,” “pay automatically in traffic peak period,” etc.

In response to the determination that an automatic payment has been set by the requestor, the processing engine 112 may intercept the automatic payment. For example, the processing engine 112 may not send the bill of the service request to the terminal so that the automatic payment cannot be triggered. As another example, the processing engine 112 may set some additional payment rules into the payment agreement, for example, “stop the automatic payment when there is an identification (e.g., an alert) in the bill of the service request.”

In step 516, the processing engine 112 may receive a response from the terminal with respect to the notification. After receiving the notification, the requestor may provide the response via the terminal (e.g., a button “help” illustrated in FIG. 6). The response may indicate whether the requestor has any questions about the transportation service, whether the requestor needs any help associated with service request, etc. In some embodiments, the response may be associated with a service fee of the service request for the transportation service. For example, the processing engine 112 may receive a request for re-determining a service fee based on an instruction from the requestor. As another example, the processing engine 112 may receive a response to dispute the service fee based on an instruction from the requestor. In some embodiments, the response may indicate that the requestor has no question about the transportation service. For example, the processing engine 112 may receive a confirmation of the bill of the service request based on a confirmation instruction from the requestor.

In step 518, the processing engine 112 may send a fee compensation to the terminal based on the response. As used herein, the fee compensation may include a discount coupon, a voucher, a re-determined service fee, or an extra fee. For example, after receiving a response to dispute the service fee based on an instruction from the requestor, the processing engine 112 may provide a discount coupon or a voucher. As another example, after receiving a request for re-determining a service fee based on an instruction from the requestor, the processing engine 112 may re-determine a service fee associated with the service request and send the re-determined service fee to the requestor terminal 130. As a further example, assuming that the processing engine 112 did not intercept the automatic payment successfully or the requestor accidentally paid the service fee, the processing engine 112 may return extra fee to the requestor terminal 130 (e.g., to the requestor account). As used herein, the processing engine 112 may determine the extra fee based on the reference fee and the actual fee.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step) may be added elsewhere in the exemplary process/method 500. As another example, assuming that the requestor has confirmed the bill of the service request in step 516, step 518 may be optional.

FIG. 6 is a schematic diagram illustrating an exemplary user interface 600 for displaying information associated with a service request according to some embodiments of the present disclosure. The user interface 600 may be presented by one or more terminals (e.g., a provider terminal 140, a requestor terminal 130, etc.). The user interface 600 may include one or more user interface elements (also referred to as the “UI elements”) for presenting information associated with the service request (e.g., the reference parameter, the actual parameter, the departure location, the destination, the actual itinerary, etc.). Each of the UI elements may be and/or include, for example, one or more buttons, icons, checkboxes, message boxes, text fields, data fields, search fields, etc.

As illustrated in FIG. 6, the user interface 600 may include a line 602 for presenting an actual itinerary between a departure location and a destination. The user interface 600 may also include one or more UI elements 604 for presenting the reference parameter. As described in connection in FIG. 4, the one or more UI elements 604 for presenting the reference parameter may include time 604a, mileage 604b, fee 604c, and the respective values associated therein. The user interface 600 may also include one or more UI elements 606 for presenting the actual parameter. As described in connection with FIG. 4, the one or more UI elements 606 for presenting the actual parameter may include time 606a, mileage 606b, fee 606c, and their respective values associated therein.

The user interface 600 may also include one or more UI elements 608 for providing user interactions to the requestor (e.g., “confirm” 608a and “help” 608b). The requestor may input a confirmation instruction via the “confirm” button. For example, when the automatic payment was intercepted by the processing engine 112, the requestor may click the “confirm” button and manually input password to complete the payment. The requestor may request for any help via the “help” button. For example, the requestor may request to re-determine a service fee via the “help” button. Further, the user interface 600 may also include one or more UI elements 612 for presenting other information (e.g., current time (e.g., “21:00 pm”)) associated with the service request.

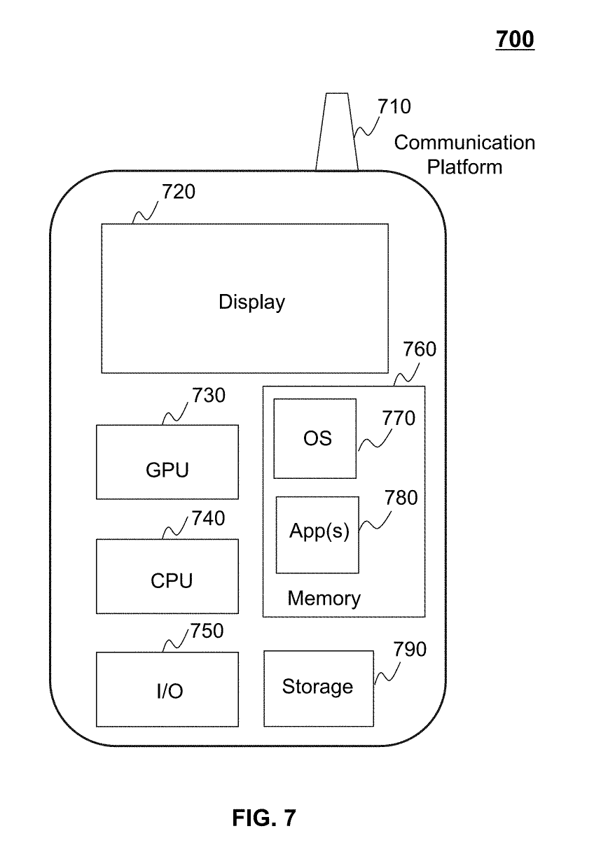

FIG. 7 is a schematic diagram illustrating exemplary hardware and/or software components of an exemplary mobile device 700 on which the requestor terminal 130 or the provider terminal 140 may be implemented according to some embodiments of the present disclosure. As illustrated in FIG. 7, the mobile device 700 may include a communication platform 710, a display 720, a graphic processing unit (GPU) 730, a central processing unit (CPU) 740, an I/O 750, a memory 760, and a storage 790. In some embodiments, any other suitable component, including but not limited to a system bus or a controller (not shown), may also be included in the mobile device 700. In some embodiments, a mobile operating system 770 (e.g., iOS™, Android™, Windows Phone™, etc.) and one or more applications 780 may be loaded into the memory 760 from the storage 790 in order to be executed by the CPU 740. The applications 780 may include a browser or any other suitable mobile apps for receiving and rendering information relating to monitoring an on-demand service or other information from, for example, the processing engine 112. User interactions with the information stream may be achieved via the I/O 750 and provided to the processing engine 112 and/or other components of the on-demand service system 100 via the network 120.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

We claim:

1. A system, comprising:
at least one storage medium including a set of instructions for monitoring an on-demand service; and
at least one processor configured to communicate with the at least one storage medium, wherein when executing the set of instructions, the at least one processor is directed to:
receive a service request from a terminal, the service request including a departure location and a destination;
determine a reference parameter based on the departure location and the destination;
determine an actual parameter based on an actual itinerary associated with the service request;
estimate a first difference between the reference parameter and the actual parameter;
determine whether the first difference exceeds a first threshold; and
send a notification to the terminal based on the determination that the first difference exceeds the first threshold.

2. The system of claim 1, wherein the reference parameter includes at least one of a reference fee associated with the service request, a reference mileage associated with the service request, or a reference time associated with the service request.

3. The system of claim 2, wherein the actual parameter includes at least one of an actual fee associated with the actual itinerary, an actual mileage associated with the actual itinerary, or an actual time associated with the actual itinerary.

4. The system of claim 3, wherein to determine the first difference between the reference parameter and the actual parameter, the at least one processor is further directed to:
determine, at least two of, a fee difference between the reference fee and the actual fee, a mileage difference between the reference mileage and the actual mileage, and a time difference between the reference time and the actual time.

5. The system of claim 4, wherein to determine the first difference between the reference parameter and the actual parameter, the at least one processor is further directed to:
determine a weighted value of at least two of the fee difference, the mileage difference, and the time difference; and
determine the first difference between the reference parameter and the actual parameter based on the weighted value.

6. The system of claim 4, wherein to determine the first difference between the reference parameter and the actual parameter, the at least one processor is further directed to:
rank at least two of the fee difference, the mileage difference, and the time difference; and
determine one of the ranked at least two of the fee difference, the mileage difference, and the time difference as the first difference between the reference parameter and the actual parameter.

7. The system of claim 1, wherein to determine the reference parameter based on the departure location and the destination, the at least one processor is further directed to:
obtain traffic information associated with the service request; and
determine the reference parameter based on the traffic information.

8. The system of claim 1, wherein to send the notification to the terminal, the at least one processor is further directed to:
obtain an arrival location associated with the actual itinerary;
determine a second difference between the arrival location and the destination;
determine whether the second difference exceeds a second threshold; and
send the notification to the terminal based on the determination that the second difference does not exceed the second threshold.

9. The system of claim 1, wherein the at least one processor is further directed to:
receive a response associated with a service fee of the service request from the terminal with respect to the notification; and
send a fee compensation to the terminal based on the response.

10. The system of claim 9, wherein the fee compensation includes a discount coupon, a voucher, a re-determined service fee, or an extra fee.

11. A method implemented on a computing device having a processor, a storage medium and a communication platform connected to a network, the method comprising:
receiving, by a processor, a service request from a terminal, the service request including a departure location and a destination;
determining, by the processor, a reference parameter based on the departure location and the destination;
determining, by the processor, an actual parameter based on an actual itinerary associated with the service request;
estimating, by the processor, a first difference between the reference parameter and the actual parameter;
determining, by the processor, whether the first difference exceeds a first threshold; and
sending, by the processor, a notification to the terminal based on the determination that the first difference exceeds the first threshold.

12. The method of claim 11, wherein the reference parameter includes at least one of a reference fee associated with the service request, a reference mileage associated with the service request, or a reference time associated with the service request.

13. The method of claim 12, wherein the actual parameter includes at least one of an actual fee associated with the actual itinerary, an actual mileage associated with the actual itinerary, or an actual time associated with the actual itinerary.

14. The method of claim 13, wherein the determining the first difference between the reference parameter and the actual parameter comprises:
determining, at least two of, a fee difference between the reference fee and the actual fee, a mileage difference between the reference mileage and the actual mileage, and a time difference between the reference time and the actual time.

15. The method of claim 14, wherein the determining the first difference between the reference parameter and the actual parameter comprises:
determining a weighted value of at least two of the fee difference, the mileage difference, and the time difference; and
determining the first difference between the reference parameter and the actual parameter based on the weighted value.

16. The method of claim 14, wherein the determining the first difference between the reference parameter and the actual parameter comprises:
ranking at least two of the fee difference, the mileage difference, and the time difference; and
determining one of the ranked at least two of the fee difference, the mileage difference, and the time difference as the first difference between the reference parameter and the actual parameter.

17. The method of claim 11, wherein the determining the reference parameter based on the departure location and the destination comprises:
obtaining traffic information associated with the service request; and
determining the reference parameter based on the traffic information.

18. The method of claim 11, wherein the sending the notification to the terminal comprises:
obtaining an arrival location associated with the actual itinerary;
determining a second difference between the arrival location and the destination;
determining whether the second difference exceeds a second threshold; and
sending the notification to the terminal based on the determination that the second difference does not exceed the second threshold.

19. The method of claim 11, further comprising:
receiving a response associated with a service fee of the service request from the terminal with respect to the notification; and
sending a fee compensation to the terminal based on the response.

20. The method of claim 19, wherein the fee compensation includes a discount coupon, a voucher, a re-determined service fee, or an extra fee.

21. A non-transitory computer readable medium, comprising at least one set of instructions for monitoring an on-demand service, wherein when executed by a processor, the at least one set of instructions directs the processor to perform acts of:
receiving a service request from a terminal, the service request including a departure location and a destination;
determining a reference parameter based on the departure location and the destination;
determining an actual parameter based on an actual itinerary associated with the service request;
estimating a first difference between the reference parameter and the actual parameter;
determining whether the first difference exceeds a first threshold; and
sending a notification to the terminal based on the determination that the first difference exceeds the first threshold.
